(19) United States
(12) Patent Application Publication
(10) Pub. No.: US 2025/0191018 A1
(43) Pub. Date: Jun. 12, 2025

(54) DYNAMIC USER-DRIVEN MARKETING AND COMPENSATION SYSTEMS

(71) Applicant: Richard Gaustad, Stansbury Park, UT (US)

(72) Inventor: Richard Gaustad, Stansbury Park, UT (US)

(21) Appl. No.: 18/963,310

(22) Filed: Nov. 27, 2024

Related U.S. Application Data
(60) Provisional application No. 63/606,991, filed on Dec. 6, 2023.

(51) Int. Cl. G06Q 30/0214; G06F 16/901; G06Q 20/40

(52) U.S. Cl. CPC G06Q 30/0214; G06F 16/9027; G06Q 20/4014

(57) ABSTRACT

A dynamic marketing and compensation system operates through multiple access pathways to facilitate user registration and engagement. The system automatically determines and establishes parent-child relationships between users based on their interactions, without requiring manual affiliate link inputs. Upon confirmed interactions through various communication interfaces, the system assigns and records hierarchical relationships in a genealogical structure. When any user upgrades to a paid version, the commission calculation engine processes payments through the established genealogy, compensating referring users and their upline connections according to predefined rules, thereby incentivizing organic network growth through natural user interactions.

The present application claims the benefit of U.S. Provisional Patent Application No. 63/606,991 entitled “Dynamic user-driven marketing and compensation systems,” filed on Dec. 6, 2023. The entire contents of the above-listed application are hereby incorporated by reference for all purposes.

### BACKGROUND

The field of integrated digital ecosystems represents the convergence of various technologies and applications, communication systems, and affiliate marketing, where digital platforms and tools enable multifaceted user experiences. In this expansive domain, a distinct field of systems have materialized that combine software applications with affiliate marketing to establish parent-child relationships among users. This specialized field is characterized by the utilization of algorithms to establish a network for providing users with opportunities for commission earnings and bolstering organizational growth.

### BRIEF DESCRIPTION OF THE DRAWINGS

The present description will be understood more fully when viewed in conjunction with the accompanying drawings of various examples of dynamic user-driven marketing and compensation systems. The description is not meant to limit the dynamic user-driven marketing and compensation systems to the specific examples. Rather, the specific examples depicted and described are provided for explanation and understanding of dynamic user-driven marketing and compensation systems. Throughout the description the drawings may be referred to as drawings, figures, and/or FIGs.

FIG. 1 illustrates a dynamic user-driven marketing and compensation system, according to an embodiment;

FIG. 2 illustrates a device schematic for various devices used in the dynamic user-driven marketing and compensation system shown in FIG. 1, according to an embodiment.

FIG. 3 is a flow diagram illustrating a method for using a dynamic user-driven marketing and compensation system, according to an embodiment;

FIG. 4 illustrates a representation of a user registration process within an application of a dynamic user-driven marketing and compensation system, according to an embodiment;

FIG. 5 illustrates a depiction of a user onboarding process within an application of a dynamic user-driven marketing and compensation system, according to an embodiment;

FIG. 6 illustrates a decision-making process for assigning a parent-child relationship within an application of a dynamic user-driven marketing and compensation system, according to an embodiment;

FIG. 7A illustrates a hierarchical commission distribution structure showing generational bonus allocations within an application of a dynamic user-driven marketing and compensation system, according to an embodiment;

FIG. 7B illustrates an example of how the commission structure may be implemented in a family-style referral network, according to an embodiment;

FIG. 8 illustrates a user registration process for an application of a dynamic user-driven marketing and compensation system, according to an embodiment;

FIG. 9 illustrates a process of integrating a new user into an application of a dynamic user-driven marketing and compensation system, according to an embodiment; and

FIG. 10 illustrates a process of establishing a parent-child relationship within a dynamic user-driven marketing and compensation system, according to an embodiment.

### DETAILED DESCRIPTION

A dynamic user-driven marketing and compensation system as disclosed herein will become better understood through a review of the following detailed description in conjunction with the figures. The detailed description and figures provide merely examples of the various embodiments of the dynamic user-driven marketing and compensation system. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A conventional user-driven marketing and compensation system offers a basic version of their software for free and encourages users to upgrade to a paid version with additional features. As such, the primary way a conventional user-driven marketing and compensation system attracts paying customers is through advertising or direct sales efforts.

However, there are several issues with this approach. First, it can be expensive and inefficient to rely solely on advertising or direct sales to convert free users into paying customers. Second, users may not always find the added features compelling enough to upgrade. This can result in missed revenue opportunities. Finally, the lack of a structured system for user referrals and incentives means that users are not motivated to actively promote the software to others.

Implementations of dynamic user-driven marketing and compensation systems address some or all of the problems described above. Embodiments of dynamic user-driven marketing and compensation systems may include automatically tracking and rewarding users who refer others to the software, creating a network of interconnected users. Additionally, implementations of dynamic user-driven marketing and compensation systems include offering tangible incentives to encourage users to upgrade to paid versions.

The disclosed embodiments of the subject technology introduce a system and method that automatically tracks user referrals and generates rewards for referrers and offers incentives for users to upgrade to paid versions. By aligning the interests of software providers and users, the disclosed embodiments provide a novel solution for the marketing and monetization of software, resulting in a more efficient and mutually beneficial system.

Embodiments of dynamic user-driven marketing and compensation methods and systems for optimizing software marketing involving multiple users may include offering a software product facilitating real-time interactions among users, creating a link between a new user and a referring user upon installation, recording this referral, and building a user genealogy network based on referrals. Additionally, the disclosed embodiments may include compensating referring users when users within the genealogy upgrade to a paid version. Furthermore, the disclosed embodiments may include distributing commissions and expanding compensation across predefined genealogy levels, thus, motivating user referrals and network growth.

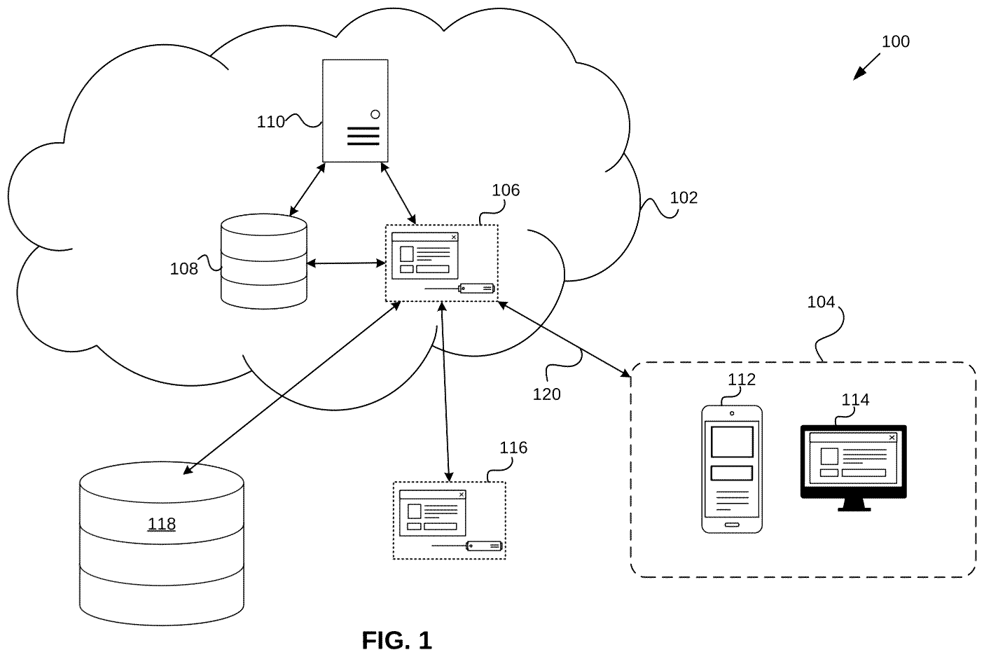

FIG. 1 illustrates a dynamic user-driven marketing and compensation system 100, according to an embodiment. The dynamic user-driven marketing and compensation system 100 includes internal and external data resources for enhancing the marketing channels of software products that require two or more users. The user-driven marketing and compensation system 100 may result in reduced memory allocation at client devices and may conserve memory resources for application servers.

The dynamic user-driven marketing and compensation system 100 may include a cloud-based data management system 102 and a user device 104. The cloud-based data management system 102 may include an application server 106, a database 108, and a data server 110. The user device 104 may include one or more devices associated with user profiles of the marketing and compensation system 100, such as a smartphone 112 and/or a personal computer 114. The marketing and compensation system 100 may include external resources such as an external application server 116 and/or an external database 118. The various elements of the dynamic user-driven marketing and compensation system 100 may communicate via various communication links 120. An external resource may generally be considered a data resource owned and/or operated by an entity other than an entity that utilizes the cloud-based data management system 102 and/or the user device 104.

The dynamic user-driven marketing and compensation system 100 may be web-based. The user device 104 may access the cloud-based data management system 102 via an online portal set up and/or managed by the application server 106. The dynamic user-driven marketing and compensation system 100 may be implemented using a public internet. The dynamic user-driven marketing and compensation system 100 may be implemented using a private intranet. Elements of the dynamic user-driven marketing and compensation system 100, such as the database 108 and/or the data server 110, may be physically housed at a location remote from an entity that owns and/or operates the system 100. For example, various elements of the dynamic user-driven marketing and compensation system 100 may be physically housed at a public service provider such as a web services provider. Elements of the dynamic user-driven marketing and compensation system 100 may be physically housed at a private location, such as at a location occupied by the entity that owns and/or operates the dynamic user-driven marketing and compensation system 100.

The communication links 120 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long-term evolution (LTE) standard, and so forth. “Indirect,” when used regarding the communication links 120, may refer to any of the aforementioned indirect communication links.

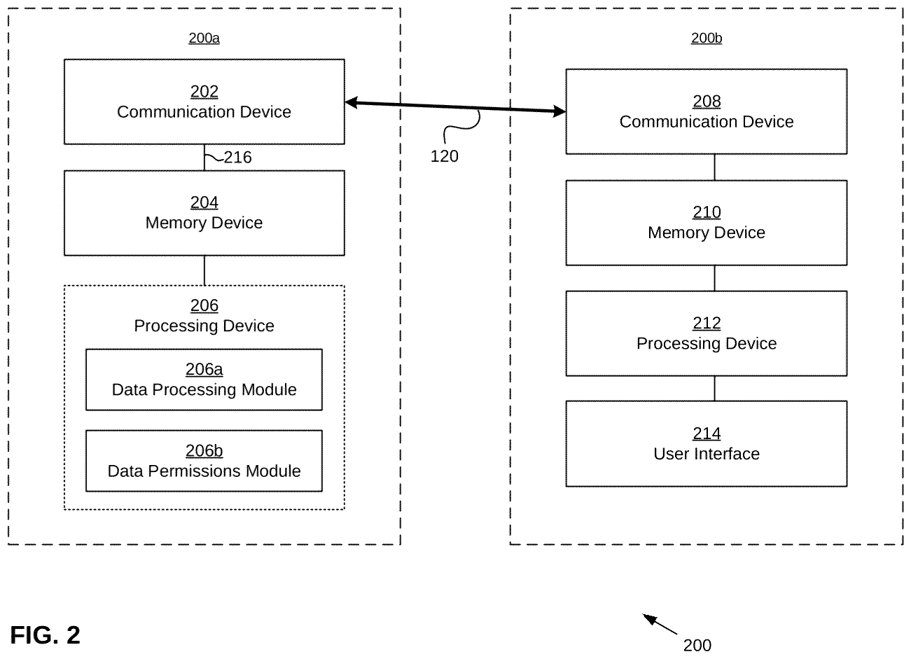

FIG. 2 illustrates a device schematic 200 for various devices used in the dynamic user-driven marketing and compensation system 100, according to an embodiment. A server device 200a may moderate data communicated to a client device 200b based on data permissions to minimize memory resource allocation at the client device 200b.

The server device 200a may include a communication device 202, a memory device 204, and a processing device 206. The processing device 206 may include a data processing module 206a and a data permissions module 206b, where module refers to specific programming that governs how data is handled by the processing device 206. The client device 200b may include a communication device 208, a memory device 210, a processing device 212, and a user interface 214. Various hardware elements within the server device 200a and/or the client device 200b may be interconnected via a system bus 216. The system bus 216 may be and/or include a control bus, a data bus, and address bus, and so forth. The communication device 202 of the server device 200a may communicate with the communication device 208 of the client device 200b.

The data processing module 206a may handle inputs from the client device 200a. The data processing module 206a may cause data to be written and stored in the memory device 204 based on the inputs from the client device 200b. The data processing module 206a may retrieve data stored in the memory device 204 and output the data to the client device 200a via the communication device 202. The data permissions module 206b may determine, based on permissions data stored in the memory device, what data to output to the client device 200b and what format to output the data in (e.g. as a static variable, as a dynamic variable, and so forth). For example, a variable that is disabled for a particular user profile may be output as static. When the variable is enabled for the particular user profile, the variable may be output as dynamic.

The server device 200a may be representative of the cloud-based marketing and compensation system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the client device 200b may be representative of the user device 104. The client device 200b may be representative of the smartphone 112. The client device 200b may be representative of the personal computer 114. The memory device 210 may store application instructions that, when executed by the processing device 212, cause the client device 200b to perform various functions associated with the instructions, such as retrieving data, processing data, receiving input, processing input, transmitting data, and so forth.

As stated above, the server device 200a and the client device 200b may be representative of various devices of the dynamic user-driven marketing and compensation system 100. Various of the elements of the dynamic user-driven marketing and compensation system 100 may include data storage and/or processing capabilities. Such capabilities may be rendered by various electronics for processing and/or storing electronic signals. One or more of the devices in the dynamic user-driven marketing and compensation system 100 may include a processing device. For example, the cloud-based marketing and compensation system 102, the user device 104, the smartphone 112, the personal computer 114, the external application server 116, and/or the external database 118 may include a processing device. One or more of the devices in the marketing and compensation system 100 may include a memory device. For example, the cloud-based marketing and compensation system 102, the user device 104, the smartphone 112, the personal computer 114, the external application server 116, and/or the external database 118 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the dynamic user-driven marketing and compensation system 100. Such memory allocation may be based on instructions stored in the memory device. Memory resources at a specific device may be conserved relative to other systems that do not associate variables and other objects with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various of the devices in the dynamic user-driven marketing and compensation system 100 may include data communication capabilities. Such capabilities may be rendered by various electronics for transmitting and/or receiving electronic and/or electromagnetic signals. One or more of the devices in the dynamic user-driven marketing and compensation system 100 may include a communication device, e.g., the communication device 202 and/or the communication device 208. For example, the cloud-based marketing and compensation system 102, the user device 104, the smartphone 112, the personal computer 114, the application server 116, and/or the external database 118 may include a communication device.

The communication device may include, for example, a networking chip, one or more antennas, and/or one or more communication ports. The communication device may generate radiofrequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the dynamic user-driven marketing and compensation system 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the dynamic user-driven marketing and compensation system 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the dynamic user-driven marketing and compensation system 100 and/or various elements of the dynamic user-driven marketing and compensation system described above. For example, inputs indicated as being received in a method may be input at the client device 200b and/or received at the server device 200a. Determinations made in the methods may be outputs generated by the processing device 206 based on inputs stored in the memory device 204. Correlations performed in the methods may be executed by the correlation module 206a. Inference outputs may be generated by the inference module 206b. Key data and/or actionable data may be stored in a knowledge database. Correlations between key data and actionable data may be stored in the knowledge database. Outputs generated in the methods may be output to an output database and/or the client device 200b. In general, data described in the methods may be stored and/or processed by various elements of the dynamic user-driven marketing and compensation system 100.

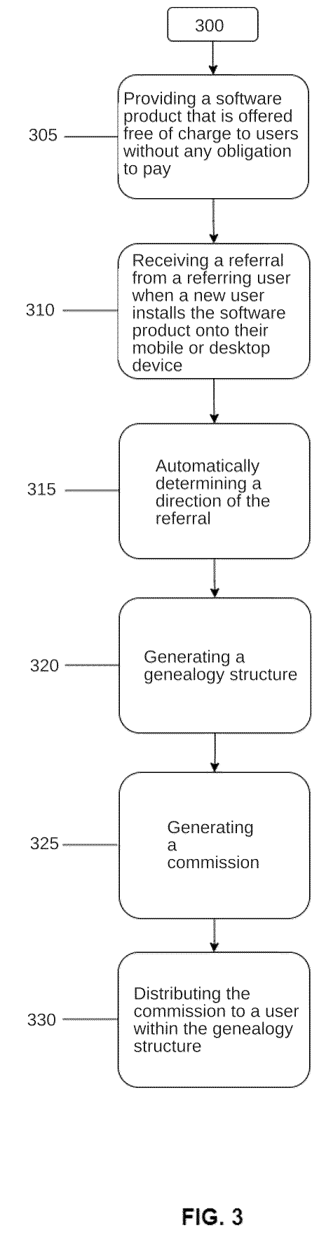

FIG. 3 is a flow diagram illustrating a method for using a dynamic user-driven marketing and compensation system, according to an embodiment. Operating the system may allow users to leverage their natural interconnectedness in the digital realm to accelerate user acquisition and engagement while boosting revenue for software providers.

In the operation of the disclosed method 300 for enhancing the marketing channels of software products that require the involvement of two or more users 305, the process may begin by providing a software product. The software product may be provided to users completely free of charge, and there is no obligation for users to make any payment. Additionally, the software product may have the capability to facilitate real-time interactions among the two or more users who engage with it.

As the process proceeds, the next step in the method 300 may comprise receiving a referral from a referring user 310 The referral may occur when a new user installs the software product onto their mobile or desktop device. Upon the users establishing a communication link or connection between each other, the referral action may create a connection or link between the new user and the referring user within the software product. The referral data may be securely stored within a database system or memory, such as the memory device integrated into the server infrastructure.

Continuing with the process, performing the method 300 may also comprise automatically determining a direction of the referral 315. Specifically, the method may identify that the new user was indeed referred by the specific referring user. This information is then stored within a memory or database, such as the database 108, for future reference.

The method 300 may further comprise generating a genealogy structure 320 comprising a network of users linked to each other based on their referrals, wherein each new user who downloads and installs the software product creates additional links in the genealogy. The genealogy structure may be managed and scaled through various server infrastructure and database systems where each new user's installation action automatically adds links to this structure, thereby creating a hierarchical network (hereinafter referred to as the “automated linking system”). The automated linking system may establish a parent-child relationship between the pre-existing referring user (the “parent”) and the newly referred user (the “child”). The automated linking system may be integrated into the hardware components of the system.

As an example, the method 300 may comprise utilizing an algorithm to create the parent-child relationship. The algorithm may be triggered and executed when two or more users within an application of the system directly interact for the first time while actively utilizing the application. The interaction may occur within the application itself or through a connection facilitated by an API. Specifically, the algorithm may establish the parent-child relationship by closely monitoring interactions between the two or more users within the application. For example, the algorithm may track instances where two or more users engage directly with each other for the first time, often through communication or collaboration activities. When this initial interaction occurs, the algorithm may identify one user as the ‘parent’ and the other as the ‘child’ based on the context and nature of their interaction. The algorithm's decision may be made based on the principle that the user who initiates the interaction or plays a certain role within the interaction is designated as the ‘parent,’ while the other user involved is designated as the ‘child.’ It will be appreciated that while the method (300) may be used to operate a software application for facilitating communication and collaboration among two or more users, the method may be adaptable to a variety of use cases.

Next, when a user within the genealogy structure pays for a software update, performing the method 300 may comprise generating a commission 325. Various servers and/or hardware components may be utilized to compute the commission, and the commission may be intended to compensate the referring user who initially referred the user who upgraded. It will be appreciated that the genealogy structure may be “one,” meaning a single commission is sent to the referring affiliate).

Once the parent-child relationship is established within the application's system, the method 300 may comprise distributing various benefits like commission to the users based on the assignment or designation 330. Specifically, the method 300 may comprise making automated determinations regarding which user, designated as the ‘parent,’ is entitled to receive a commission when a new user, the ‘child,’ either registers within the application or completes an online purchase, thereby eliminating the reliance on standard affiliate links and promoting efficient and user-friendly operations. If the application comprises a pre-existing integrated affiliate or reward system, the application may interface with this system, invoking a referral assignment feature to establish the parent-child assignment. In cases where no such affiliate or reward system is integrated into or connected with the application, the system may be customized to autonomously determine the parent-child assignment and subsequently effectuate it within the application. In this regard, the method may obviate the necessity for any user intervention or reliance on affiliate links or the like and may ensure a fair and transparent distribution of rewards and benefits within the application.

Performing the method 300 may further comprise automatically generating and distributing commissions to users within the genealogy structure for a predefined number of levels above the user who paid for the upgrade. Secure financial transactions may be a part of the hardware components utilized. Accordingly, users may be incentivized to earn compensation for their involvement in referring new users and actively contribute to the expansion of the genealogy structure which in turn fosters a mutually beneficial relationship among users. It will be appreciated that, in one embodiment, the number of levels may be set to “0” in the event the company using the invention only wishes to pay a referring affiliate with no bonus generations.

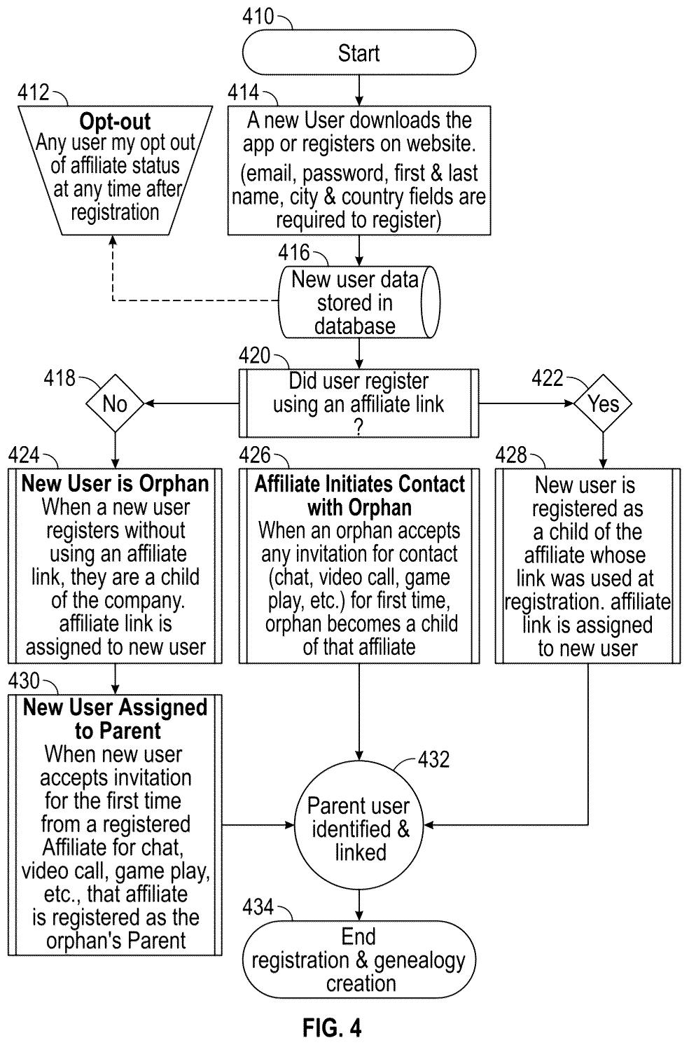

FIG. 4 illustrates a representation of a user registration process within an application of the system, according to an embodiment. Specifically, FIG. 4 shows how affiliates can initiate contact with “orphans,” and when such an invitation for interaction is accepted for the first time, the “orphan” may transform into a “child of that affiliate.” This process may assist in identifying and establishing the parent-child relationships.

The process may initiate when a new user downloads the application or registers on a website. During registration, specific user information, including email, password, first and last name, city, and country, may be required and subsequently stored in a database. Notably, users have the option to opt out of their affiliate status at any point post-registration.

FIG. 4 illustrates a representation of a user registration process within an application of a dynamic user-driven marketing and compensation system, according to an embodiment. Starting with registration & genealogy creation 410 initiates the process with opt out—any user may opt out of affiliate status after registration 412 available after registration. When new user downloads app, the app uses geolocation information, registers with required fields 414 begins, and so forth, the new user data stored in database 416 captures their information.

The process branches based on did user register using an affiliate link—decision point 420, where no—user did not register using affiliate link 418 leads to one path, and yes—user registered using affiliate link 422 leads to another. For non-affiliate registrations, new user is orphan—child of the company 424 status is assigned and affiliate link is assigned to new user 426. Alternatively, new user registered as child of the affiliate 428 occurs for affiliate-linked registrations. The process then proceeds through new user assigned to parent 430 and parent user identified and linked 432 to establish the relationship structure. The process concludes when end—registration & genealogy creation complete 434 confirms all relationships are properly established. Multiple pathways through new user data stored in database 416 ensure proper recording, while new user is orphan—child of the company 424 status may be updated based on subsequent interactions.

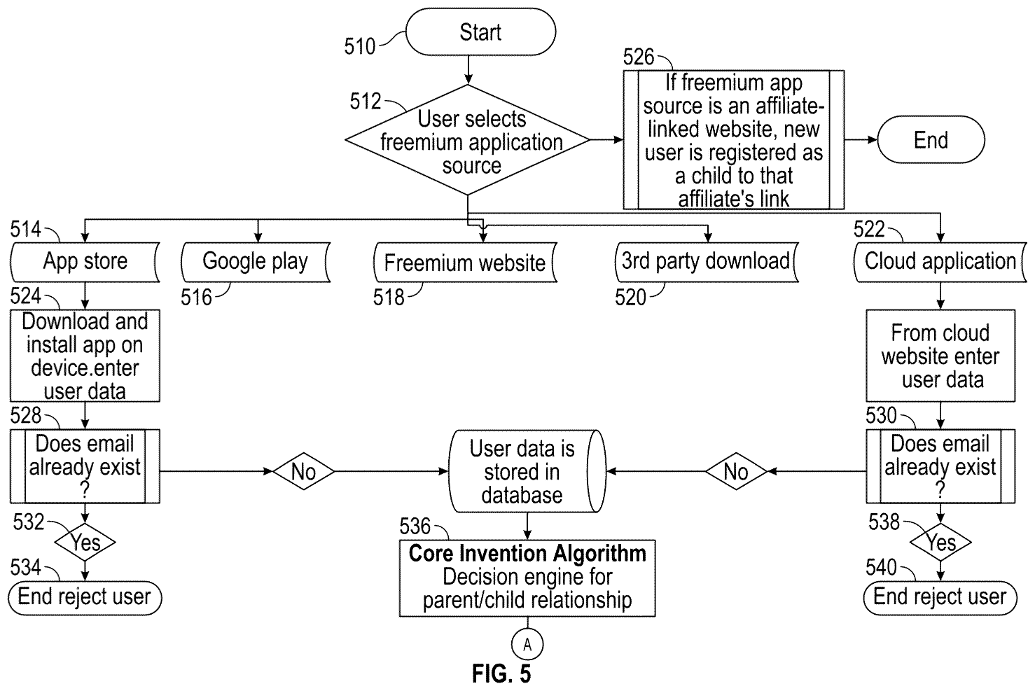

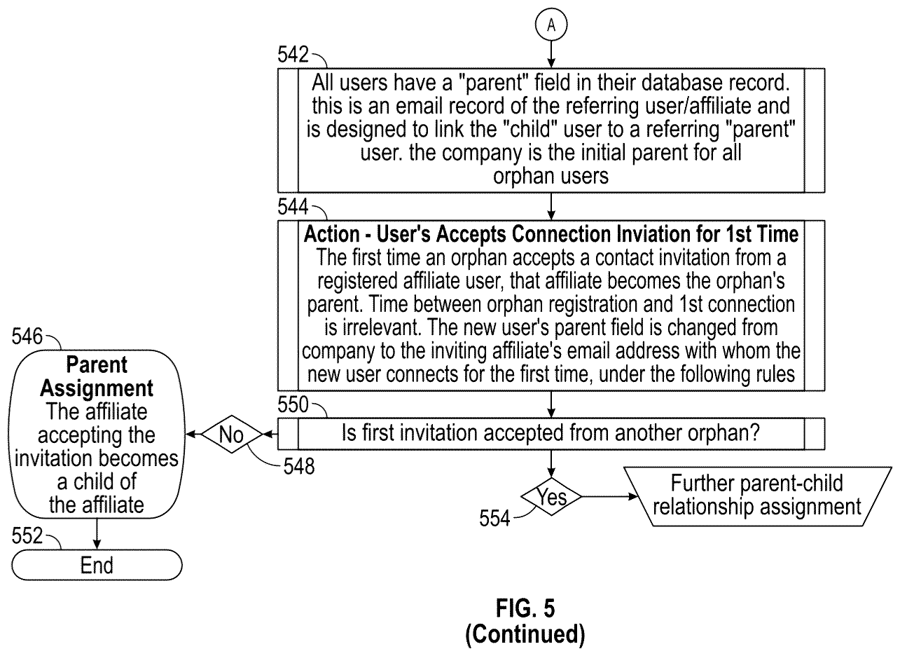

FIG. 5 illustrates a depiction of a user onboarding process within an application of a dynamic user-driven marketing and compensation system, according to an embodiment. The process begins at start-user selection process initialization 510, where user selects available freemium application source 512 offers multiple pathways: app store marketplace pathway 514, google play distribution pathway 516, freemium direct website pathway 518, verified 3rd party download pathway 520, and authorized cloud application pathway 522.

Following download and install app on user device with required data entry 524 or freemium app source is affiliate-linked website with automatic child status 526, the system performs does email already exist in database—first validation check 528 and next does email already exist in database-secondary validation check 530. When yes-email exists in database (initial verification) 532 occurs, it leads to end reject user—first validation failure 534, while an algorithm decision engine for parent assignment 536 processes next yes—email exists in database (secondary verification) 538 and next end reject user—secondary validation failure 540.

The system ensures all users have parent field in database record with company designation 542 before proceeding to action-user accepts first connection invitation for parent assignment 544. The verification validates parent assignment, where the initial relationship establishment 546, when no—first parent assignment validation check 548 and is first invitation accepted from another registered user 550 guide the process to either: end—first process completion with validation 552; yes—accept first invitation with parent assignment 554, or further parent-child relationship assignment steps follow 556.

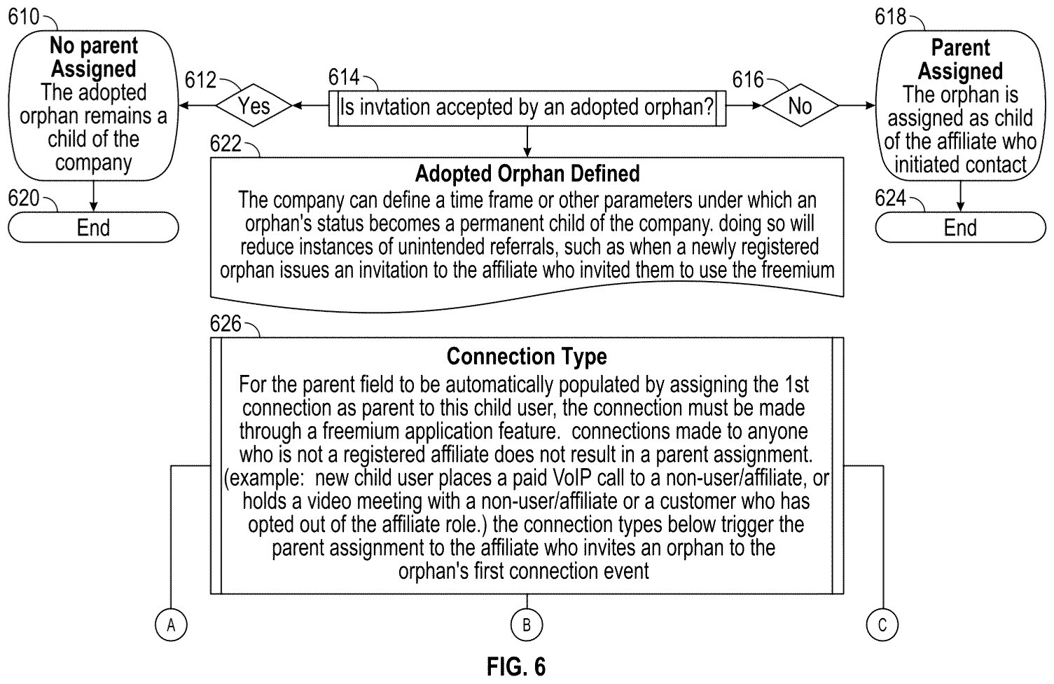

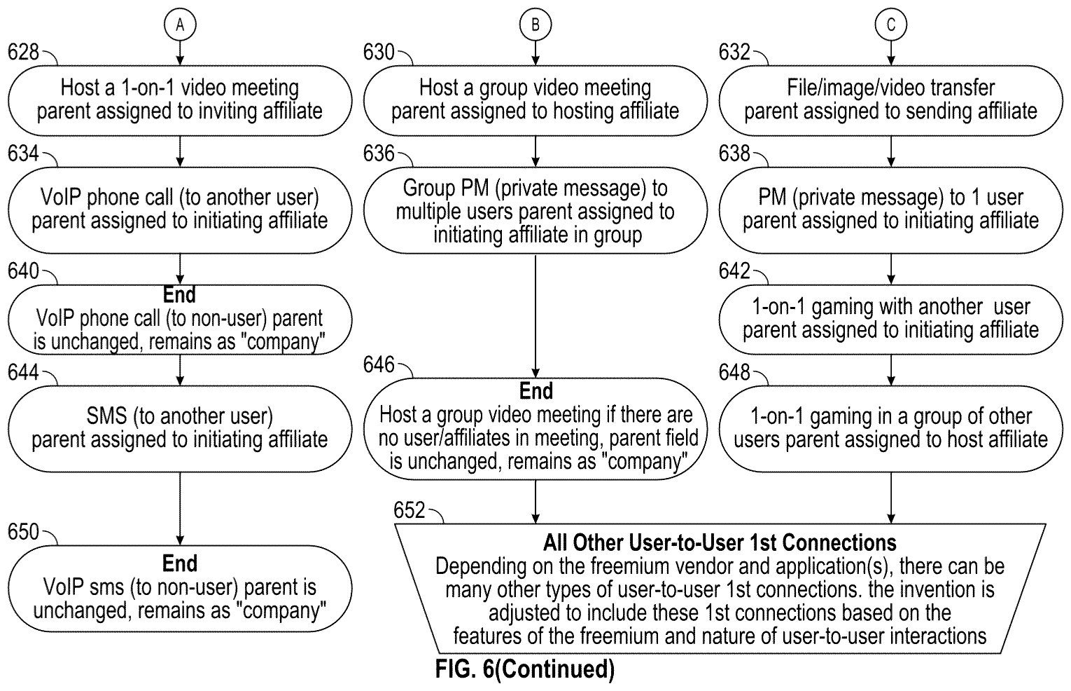

FIG. 6 illustrates a decision-making process for assigning a parent-child relationship within an application of a dynamic user-driven marketing and compensation system, according to an embodiment. The process begins by determining when no parent assigned-adopted affiliate is permanent child of company 610 is appropriate. This involves evaluating yes—orphan accepted first contact 612 after first contact with adopted or orphan status 614 is checked, or no-first contact connection required 616 leading to parent assigned-earliest time/date determines parent 618.

The process may reach end-no parent assignment required 620 after adopted and orphan status defined—company time frame parameters 622 is established, leading to end—status definition complete 624. Connection type—primary Automated Referral Assignment Module (hereinafter “ARAM”) parent decision requirements 626 governs various interaction types: host 1-on-1 video meeting—parent assigned by date/time stamp 628, host group video meeting—parent assigned by date/time stamp 630, and file/image/video transfer—parent assigned by date/time stamp 632.

For user communications, VoIP phone call to user-parent assigned by date/time stamp 634, group PM (Private Message) to multiple users—parent assigned by date/time stamp 636, and pm to 1 user—parent assigned by date/time stamp 638 follow timestamp rules, while end VoIP phone call to non-user—parent remains as company 640 maintains company status. The 1-on-1 gaming with another user-parent assigned to initiating affiliate 642 has unique assignment rules. Additional channels include chat with another user—parent assigned by date/time stamp 644, with end host group video meeting no users—parent remains as company 646 and 1-on-1 gaming in group—parent assigned by date/time stamp 648 having specific conditions. The process concludes with end VoIP chat to non-user—parent remains as company 650 for certain cases while all other user-to-user earliest time/date interactions 652 follow standard timestamp rules.

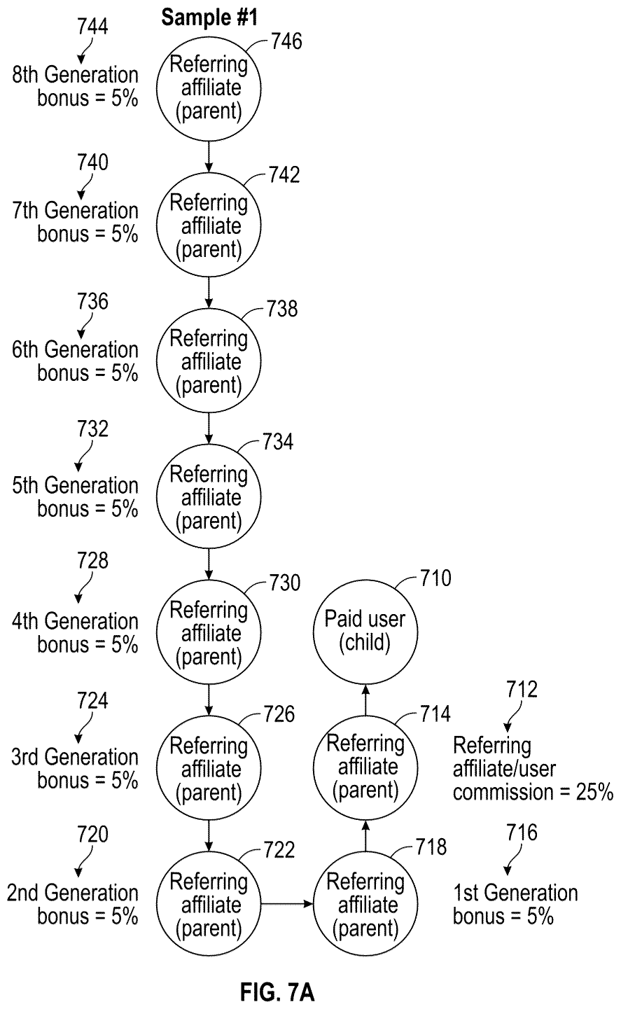

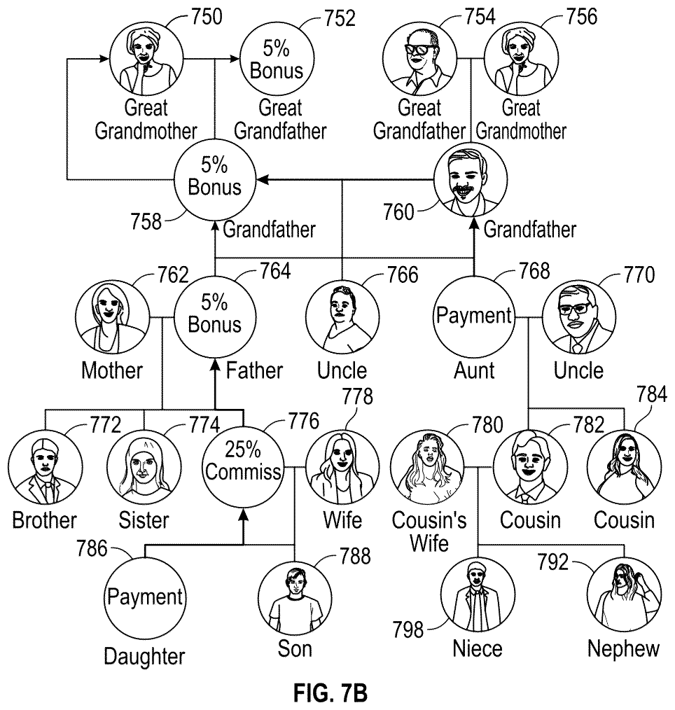

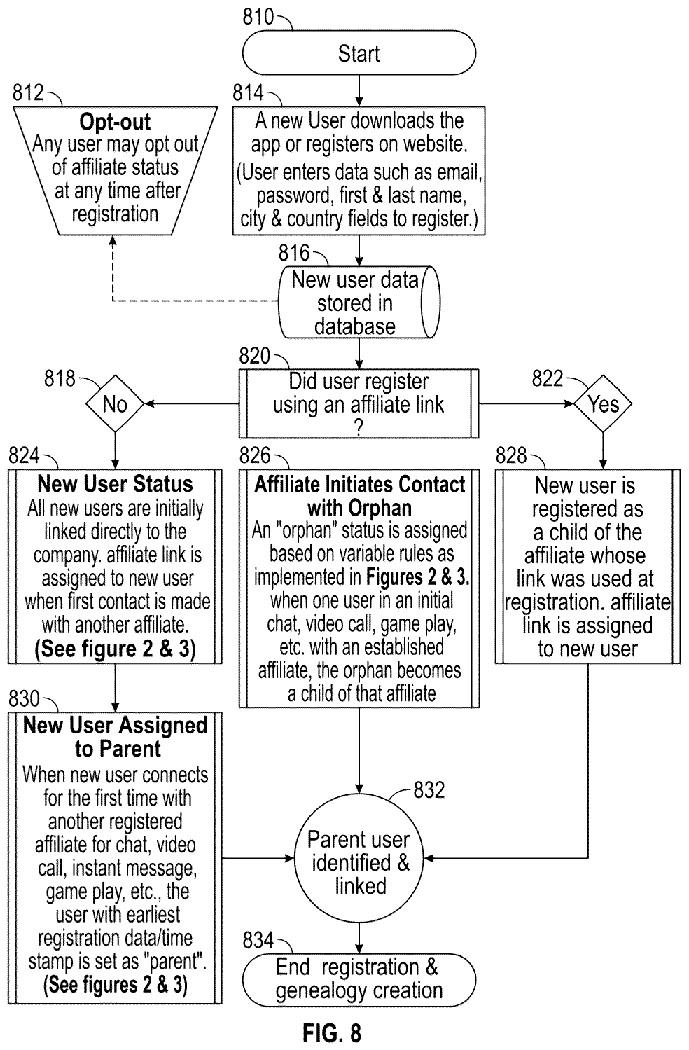

FIG. 7A illustrates a hierarchical commission distribution structure showing generational bonus allocations within an application of a dynamic user-driven marketing and compensation system, according to an embodiment. This structure implements the commission generation and distribution processes detailed in steps 325 and 330, while providing the scalable genealogy structure described in paragraph 48. The structure begins with the “paid user (child)” 710 who triggers “referring affiliate/user commission=25%” 712 for their direct referrer, implementing the initial commission generation described in step 325. Above this, the “first generation referring affiliate (parent)” 714 receives “first generation bonus=5%” 716, while “second generation referring affiliate (parent)” 718 earns “second generation bonus=5%” 720, following the predefined genealogy levels previously described.

Moving upward through the automated linking system described in paragraph 48, “third generation referring affiliate (parent)” 722 receives “third generation bonus=5%” 724, and “fourth generation referring affiliate (parent)” 726 qualifies for “fourth generation bonus=5%” 728.

The structure continues through “fifth generation referring affiliate (parent)” 730 earning “fifth generation bonus=5%” 732, followed by “sixth generation referring affiliate (parent)” 734 receiving “sixth generation bonus=5%” 736, demonstrating the expanding compensation described in paragraph 52. Near the top levels, “seventh generation referring affiliate (parent)” 738 earns “seventh generation bonus=5%” 740, and finally “eighth generation referring affiliate (parent)” 742 receives “eighth generation bonus=5%” 744, completing the mutually beneficial relationship structure previously described.

FIG. 7B illustrates a practical implementation of the commission distribution structure through a family-based referral network within an application of a dynamic user-driven marketing and compensation system, according to an embodiment. This structure demonstrates the real-world application of steps 325 and 330, showing how the genealogy structure described in paragraph 48 maps to familiar relationships.

Starting from “great grandmother” 750, the family tree structure extends through “great grandfather” 752 who receives a 5% bonus implementing step 330's multi-level compensation, alongside “other great grandfather” 754 and “other great grandmother” 756. At the next level, “grandmother” 758 connects to “grandfather” 760 who also receives a 5% bonus, demonstrating the automated linking system from paragraph 48. The structure continues through “mother” 762 and “father” 764 who earns another 5% bonus, with “uncle” 766 branching to the side, showing the flexible network topology described in step 320. “Aunt” 768 receives a payment, as does “other uncle” 770 in their branch, implementing the commission distribution detailed in step 330.

The middle generation includes “brother” 772, “sister” 774, and “husband” 776 who earns the 25% commission described in step 325, along with “wife” 778. The extended family includes “cousin's wife” 780, “cousin” 782, and “other cousin” 784, demonstrating the expansive network capabilities outlined in paragraph 52.

In the newest generation, “daughter” 786 receives a payment following step 330's distribution rules, while “son” 788, “nephew” 790, and “niece” 792 complete the family structure, showing how the mutually beneficial relationships described in paragraph 52 map to natural family connections.

FIG. 8 illustrates a user registration process for an application of a dynamic user-driven marketing and compensation system, according to an embodiment. The process begins with start-registration & genealogy creation 810, similar to the previously discussed general start procedure. During this phase, opt out—any user may opt out of affiliate status 812 remains available, following the previously discussed opt out protocol. The new user downloads app or registers with required fields 814 follows the previously discussed download procedure, leading to new user data stored in database 816, which mirrors the previously discussed data storage process. The system then reaches did user register with affiliate link?-decision point 820.

At this stage, based on whether no-user did not register with affiliate link 818 or yes-user registered with affiliate link 822 is determined, different paths emerge, similar to the previously discussed bifurcation process. The process then establishes new user status—initial company link 824 while affiliate initiates first contact 826 may occur. This leads to when new user is registered as child of affiliate 828, which follows the previously discussed child-affiliate relationship model. Once confirmed, new user assigned to parent 830 proceeds.

The parent user identified and linked-relationship established 832 confirms the structural connection before end—registration & genealogy creation complete 834 finalizes the process. Multiple verification points through new user status—initial company link 824 ensure proper assignment, while new user assigned to parent 830 remains crucial for relationship establishment, building upon the previously discussed parent-child framework.

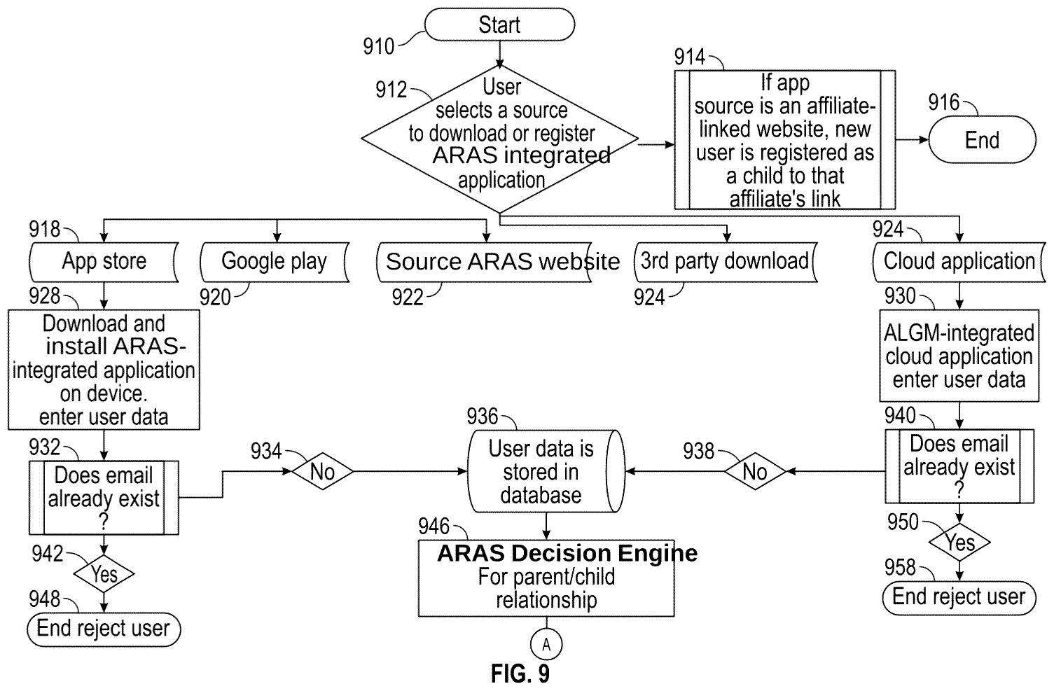

FIG. 9 illustrates a process of integrating a new user into an application of a dynamic user-driven marketing and compensation system, according to an embodiment. The process initiates at start-user selection process 910, where user selects source point 912 determines the path forward. Similar to the previously discussed registration options, if app source is affiliate-linked 914 leads to either immediate end-source selection complete 916 or various selection paths including app store selection 918, Google Play® selection 920, ARAS website selection 922, cloud application selection 924, and 3rd party download selection 926.

The user then proceeds through either download and install ARAS process 928 or Automated Linking and Genealogy Module (hereinafter “ALGM)—integrated process 930, leading to does email already exist in database—first check 932. When no—email does not exist in database 934 is confirmed, the process advances to user data is stored in database 936, similar to the previously discussed data storage procedures. A parallel verification occurs through next does email already exist in database—secondary check 940, followed by next no—email does not exist in secondary check 938.

In cases where yes—email exists in database 942 is determined, the system proceeds to end—reject user due to existing email 944. Meanwhile, the ARAS decision engine for parent assignment 946 engages its parent assignment processing 948 component to handle next yes—email exists in secondary check 950.

Following the previously discussed parent-child framework, all users have a parent field requirement 952 must be satisfied before proceeding to action—user connects for first time 954. This triggers parent assignment process initiation 956, where no—parent assignment not complete 958 leads to is one of the users adopted status check 960.

The process continues through parent assignment secondary process 962, potentially involving next no—secondary parent assignment not complete 964 and next is one of the users adopted secondary check 966, before concluding at either end—parent assignment process complete 968, yes—parent assignment confirmed 970, or proceeding to ARAS parent-child assignment steps 972.

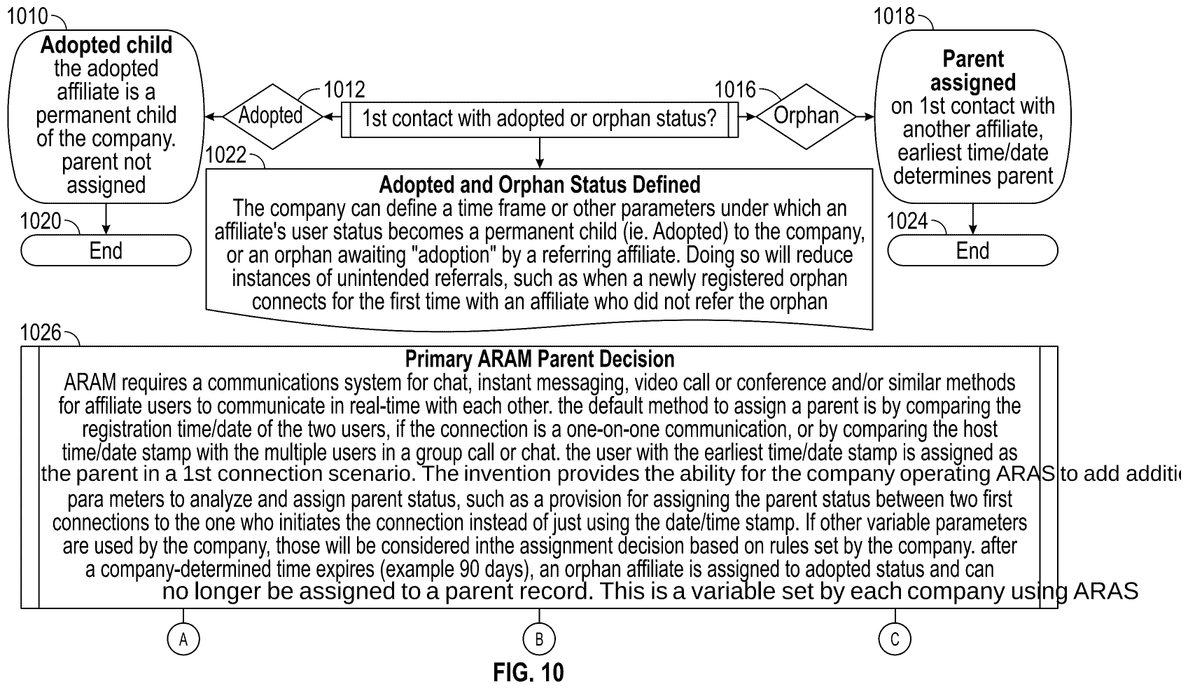

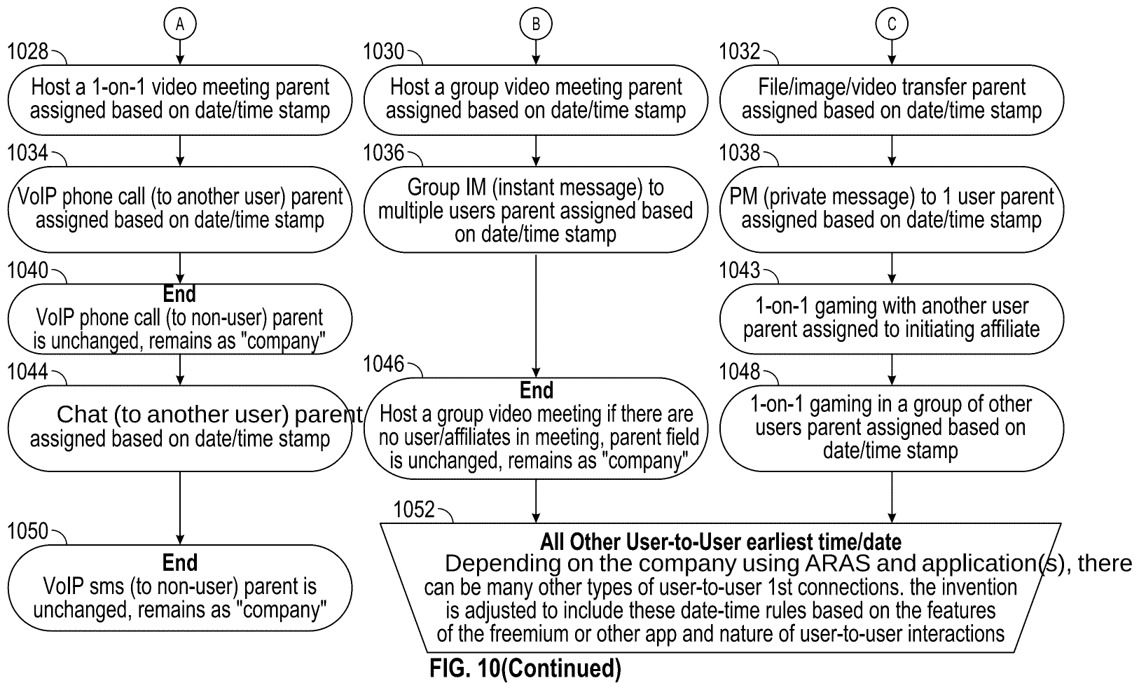

FIG. 10 illustrates a process of establishing parent-child relationships within the system, according to an embodiment. The process may begin with “first contact with adopted or orphan status?” 1010, where the method determines the direction of the referral and identifies user status. If adopted status is confirmed, the “adopted child—the adopted affiliate is a permanent child of the company” 1012 applies, leading to “parent not assigned” 1014. When orphan 1016 status is determined, the process continues to assessment. The process advances by evaluating “connection type” 1024 through the primary ARAS parent decision 1026. The genealogy structure may be managed through various server infrastructure components where each user interaction automatically triggers potential parent-child relationship assessment.

Multiple connection types may be processed through the automated linking system, including “host a 1-on-1 video meeting” 1028, “host a group video meeting” 1030, and “file/image/video transfer” 1032. The system may also process “VOIP phone call to another user” 1034, “PM to 1 user” 1036, and “group IM to multiple users” 1038, establishing parent-child relationships based on these first interactions. The method may comprise additional connection scenarios through “VoIP phone call to non-user” 1040, “chat to another user” 1042, and “VoIP chat to non-user” 1044. Each interaction may be securely stored within the database system or memory device integrated into the server infrastructure. The system may further process “host a group video meeting with no users” 1046, where the automatic determination of referral direction is assessed. Additionally, “1-on-1 gaming with another user” 1048 and “1-on-1 gaming in a group of other users” 1050 may establish parent-child relationships through direct interaction.

Finally, “all other user-to-user earliest time/date” 1052 handles remaining connection types, ensuring comprehensive genealogy structure generation comprising a network of users linked through their referrals and interactions. The system may automatically generate and distribute commissions based on these established relationships.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e, methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A system, comprising:
a multi-source application access module, comprising:
an app store application store distribution interface comprising:
an authentication module comprising;
a data structure wherein user installation data is validated;
a secure referral record created during initial software product deployment; and
download verification logic, wherein successful installation is confirmed through database record establishment prior to enabling user access;
a website registration portal comprising:
a secure socket interface, wherein encrypted data transmission occurs during user registration and referral link establishment; and
a credential management database, wherein unique user identifiers are maintained for automatic determination and storage of parent-child relationship;
a third-party download gateway comprising:
a verification pipeline, wherein user data validation occurs sequentially through defined checkpoints before enabling system access; and
cross-platform compatibility matrix, wherein application functionality maintains consistency across multiple operating environments and device type;
a user data management module, comprising:
an email verification operation with redundant validation servers and cache management protocols, wherein user identity verification occurs through multiple server checks while maintaining temporary response data;
a required field collection algorithm including data parsing modules and field relationship tables, wherein registration data fields are processed, categorized, and stored according to predetermined relationship structures; and
a parent field record rule incorporating hierarchical storage arrays and relationship mapping indices, wherein parent-child associations are organized in scalable arrays that maintain generational mapping integrity;
a communication interface module, comprising:
a video meeting interface with codec processing units and bandwidth allocation controllers, wherein real-time video communications are managed and optimized based on available network resources;
a messaging system interface containing message queuing architecture and delivery confirmation handlers, wherein user message exchanges are prioritized and confirmed through systematic delivery verification; and
a gaming interface having state synchronization modules and peer connection matrices, wherein interactive gaming sessions maintain consistent states across multiple concurrent user connections; and
a commission distribution module, comprising:
multi-generational tracking logic with genealogical tree structures and node relationship databases, wherein multiple levels of user relationships are maintained in interconnected data structures for commission calculations;
a percentage-based commission calculator including computational arrays and distribution mapping tables, wherein commissions are computed and allocated based on predefined generational percentages and relationship paths; and
a payment distribution validator containing verification checkpoints and transaction logging frameworks, wherein payment distributions undergo systematic verification before release while maintaining comprehensive transaction records.

2. The system of claim 1, wherein the parent field record connects to child users through hierarchical storage arrays; and relationship mapping indices connect genealogical structure utilizing:
genealogical tree structures; and
node relationship databases within user relationships.

3. The system of claim 1, wherein the multi-source application access module having authentication modules and verification pipelines further comprises:
an application store distribution interface with:
an encrypted application data socket interface socket interface; and
a credential management database; and
an affiliate-linked website pathway containing:
a sequential user data validation pipeline; and
a multi-environment application compatibility matrix.

4. The system of claim 1, wherein the communication interface module comprises:
a file transfer interface comprising:
a state synchronization module, wherein interactive sessions maintain consistent states across multiple concurrent user connections; and
a peer connection matrix; wherein user message exchanges are prioritized through systematic delivery verification;
a VoIP integration interface comprising:
a message queuing architecture, wherein real-time communications are managed based on available network resources; and
delivery confirmation handlers, wherein user communications undergo systematic verification before transmission confirmation; and
a chat integration interface comprising:
codec processing units, wherein data transmission is optimized through predefined processing protocols; and
bandwidth allocation controllers, wherein network resources are distributed based on communication priority.

5. The system of claim 1, wherein the commission distribution module further comprises:
a direct commission module with computational arrays configured for 25% referral payments through transaction logging frameworks; and
a generational bonus module with distribution mapping tables configured for 5% bonus payments through verification checkpoints.

6. The system of claim 1, wherein the user data management module with redundant validation servers further comprises:
an opt-out management interface incorporating hierarchical storage arrays and data parsing modules; and
a status assignment interface containing field relationship tables and relationship mapping indices.

7. The system of claim 1, wherein the commission distribution module comprises:
a first through eighth generation bonus tracking rule utilizing genealogical tree structures and computational arrays; and
a payment validation rule containing verification checkpoints and transaction logging frameworks.

8. The system of claim 1, wherein the communication interface module with bandwidth allocation controllers further comprises:
a timestamp verification rule incorporating state synchronization modules and message queuing architecture; and
a first contact establishment detection rule utilizing peer connection matrices and delivery confirmation handlers.

9. A method, comprising:
receiving a new user registration through an application store distribution interface comprising:
authenticating gateways and platform-specific handlers, wherein user installation data is validated and processed according to distribution platform requirements;
storing user data in a database, comprising:
validating email uniqueness using redundant verification servers and cache management systems;
collecting required registration fields through field parsing engines and data validation matrices; and
establishing an initial parent field record with hierarchical storage structures and relationship indices;
determining a parent-child relationship by:
detecting first contact between users using interaction monitoring arrays and connection tracking modules;
validating timestamp data of the contact through temporal verification nodes and synchronization handlers; and
assigning parent status based on contact type using relationship assignment processors and status validation frameworks;
establishing communication channels by:
video meeting interfaces with codec optimization units and bandwidth management systems;
active messaging systems containing queue processing architectures and delivery verification modules; and
a gaming interface having state management processors and peer-to-peer routing frameworks; and
calculating commissions by:
tracking multi-generational relationships using genealogical mapping engines and node relationship databases;
applying percentage-based commission rules through computational matrices and distribution algorithms; and
validating payment distributions with transaction verification checkpoints and settlement confirmation handlers.

10. The method of claim 9, wherein determining the parent-child relationship using interaction monitoring arrays and relationship assignment processors further comprises:
detecting if the contact is with an adopted user through status validation frameworks;
verifying orphan status using hierarchical storage structures; and
maintaining company parent status through relationship indices when appropriate.

11. The method of claim 9, wherein calculating commissions using genealogical mapping engines comprises:
applying a 25% commission for direct referrals through computational matrices;
calculating 5% bonuses for generational relationships using distribution algorithms; and
tracking up to eight generations of relationships using node relationship databases.

12. The method of claim 9, further comprising:
monitoring opt-out requests through temporal verification nodes;
updating affiliate status using status validation frameworks; and
maintaining relationship records with hierarchical storage structures.

13. The method of claim 9, wherein establishing communication channels with codec optimization units comprises:
validating user-to-user interactions through peer-to-peer routing frameworks;
recording timestamp data using synchronization handlers; and
updating parent assignments using relationship assignment processors.

14. The method of claim 9, further comprising:
managing non-user interactions through connection tracking modules;
maintaining company parent relationships using relationship indices; and
processing status updates through status validation frameworks.

15. A system, comprising:
a registration processing module configured to:
receive new user registrations through multiple pathways having authentication gateways and platform-specific handlers;
validate user data entries using redundant verification servers and cache management systems; and
establish initial parent-child relationships with hierarchical storage structures and relationship indices;
a process management network comprising:
a timestamp verification engine containing temporal validation nodes and synchronization protocols;
a parent assignment processor with relationship mapping arrays and status determination matrices; and
a status update controller utilizing state management frameworks and update propagation handlers;
a communication interface system configured to:
enable multiple user interaction types through codec optimization units and protocol adaptation layers;
validate interaction timestamps using temporal verification nodes and sequence tracking modules; and
process parent assignments with relationship assignment processors and validation frameworks; and
a commission calculation engine configured to:
track generational relationships using genealogical mapping engines and node relationship databases;
process percentage-based commissions through computational matrices and distribution algorithms; and
distribute validated payments with transaction verification checkpoints and settlement confirmation handlers.

16. The system of claim 15, wherein the registration processing component with authentication gateways comprises:
an app store interface containing platform-specific handlers;
a website portal with secure socket interfaces and credential management databases; and
an affiliate-linked gateway utilizing verification pipelines and cross-platform compatibility matrices.

17. The system of claim 15, wherein the process management network with temporal validation nodes comprises:
an orphan status processor utilizing state management frameworks;
an adoption status validator containing status determination matrices; and
a company parent relationship manager with hierarchical storage structures.

18. The system of claim 15, wherein the communication interface system with codec optimization units comprises:
video meeting with bandwidth management systems;
messaging system components with queue processing architectures; and
gaming interface components containing peer-to-peer routing frameworks.

19. The system of claim 15, wherein the commission calculation engine with genealogical mapping engines comprises:
a direct commission processor with computational matrices configured for 25% payments;
a generational bonus calculator containing distribution algorithms configured for 5% payments; and
a payment validation system utilizing transaction verification checkpoints.

20. The system of claim 15, further comprising:
an opt-out management system with state management frameworks;
a status assignment processor utilizing status determination matrices; and
a genealogical relationship tracker containing node relationship databases.
